(19) United States
(12) Patent Application Publication
(10) Pub. No.: US 2020/0361788 A1
(43) Pub. Date: Nov. 19, 2020

(54) METHOD FOR TREATING BY FLOTATION AN AQUEOUS SOLUTION FROM A PETROLEUM PRODUCTION

(71) Applicant: IFP Energies nouvelles, Rueil-Malmaison (FR)

(72) Inventors: Hafssa CHAKIBI, RUEIL-MALMAISON (FR); Isabelle HENAUT, RUEIL-MALMAISON (FR); Jean-Francois ARGILLIER, RUEIL-MALMAISON (FR)

(21) Appl. No.: 16/771,008

(22) PCT Filed: Nov. 12, 2018
(86) PCT No.: PCT/EP2018/080980

§ 371 Date: Jun. 9, 2020

(30) Foreign Application Priority Data
Dec. 11, 2017 (FR) 1761896

(51) Int. Cl. C02F 1/24; C02F 1/68; B01D 17/02; B01D 17/04

(52) U.S. Cl. CPC C02F 1/24; C02F 1/68; C02F 2101/301; B01D 17/047; C02F 2303/08; B01D 17/0205

(57) ABSTRACT

The invention relates to a method for treating an aqueous solution comprising at least an oil phase dispersed as drops in an aqueous phase, the oil being petroleum crude oil. According to the invention, at least the following steps are carried out: adding at least a tetravalent salt to the aqueous solution at a predetermined concentration, then separating by flotation the oil phase from the aqueous phase present in the aqueous solution to which at least the tetravalent salt has been added.

Application in particular to the treatment of a produced water or a produced effluent of petroleum origin.

### FIELD OF THE INVENTION

The present invention relates to the field of treating an aqueous solution comprising at least an oil phase dispersed as drops, the oil being notably a crude oil from oil production.

More specifically, the present invention relates to the treatment of a produced water resulting from a first water/oil separation step applied to a petroleum effluent, the effluent being for example derived from the enhanced recovery of hydrocarbons trapped within an underground formation. The present invention can also be directly applied to a petroleum effluent when this effluent is very predominantly aqueous.

### BACKGROUND OF THE INVENTION

Conventionally, an operation of enhanced recovery of hydrocarbons trapped in a geological reservoir comprises injecting a sweep fluid into an injection well, the sweep fluid driving the fluids trapped in the porous medium of the geological reservoir towards at least one production well.

Conventionally, the production string of a production well is terminated at the surface by a wellhead to which a flowline collecting the petroleum effluent thus produced is connected. This fluid is a mixture comprising part of the hydrocarbons present in the formation (in form of oil and gas), sweep fluid components (such as polymers, surfactants and/or alkaline compounds in the case of chemical EOR) and water (possibly in form of brine).

The flowline generally carries the petroleum effluent to a treatment facility that may include means for mixing, diluting, separating and/or treating oil, water and gas. Generally, the first step of the petroleum effluent treatment consists in separating the water and the oil by gravity (for example by means of a two-phase or three-phase separation method or of a Free-Water Knock-Out type equipment). The oil thus recovered is sent to desalting and dehydration processes.

The reject fluid, also referred to as produced water, is an essentially aqueous fluid, but it generally still contains oil drops and impurities. To remove these impurities and the oil drops, the water is sent to water treating processes. After this produced water treatment, a standardized quality water is discharged or (re)injected through a suitable well into an underground formation.

A known method for produced water treatment is the flotation technique, as described for example in the document (Moosai and Dawe, 2003: Moosai, Roshni & Dawe, Richard (2003). Gas attachment of oil droplets for gas flotation for oily wastewater cleanup. Separation and Purification Technology, 33(3), 303-314. Separation and Purification Technology, 33, 303-314. 10.1016/S1383-5866(03)00091-1). This technique consists in collecting at least part of the oil droplets dispersed in the aqueous phase, for example through injection of a gas into the produced water. Indeed, the assembly thus formed, made up of gas bubbles and oil droplets, has a much lower density than the oil droplets alone, which greatly accelerates the gravity-driven oil/water separation. However, collection of the oil droplets by flotation is sometimes slow or inefficient.

The goal of the present invention is to improve the efficiency and the speed of the flotation separation of the oil and water phases present in an aqueous solution comprising oil drops in dispersed form, such as produced water. Notably, the method according to the invention comprises a step consisting in adding at least tetravalent cations to the produced water, prior to the oil/water flotation separation step.

### SUMMARY OF THE INVENTION

In general, the invention relates to a method for treating an aqueous solution comprising at least an oil phase dispersed as drops in an aqueous phase, said oil being a petroleum crude oil. The invention comprises at least the following steps:

a) adding at least one tetravalent salt to said aqueous solution according to a predetermined concentration,

b) separating by flotation said oil phase from said aqueous phase present in said aqueous solution to which at least said salt has been added.

According to an implementation of the invention, said concentration can be predetermined in such a way that the zeta potential of said oil drops ranges between −20 mV and +20 mV.

Advantageously, said concentration can be predetermined in such a way that the zeta potential of said oil drops ranges between −10 mV and +10 mV.

According to an implementation of the invention, the tetravalent salt can be a zirconium salt.

Advantageously, the zirconium salt can be a zirconium chloride.

Preferably, at least one anti-corrosion agent can be injected simultaneously with said zirconium chloride.

According to an implementation of the invention, said tetravalent salt concentration can range between 0.05 ppm and 50 ppm.

According to a variant embodiment of the invention, said flotation can be performed at least by injecting a gas into said aqueous solution.

Preferably, said injected gas can be nitrogen.

According to another variant embodiment of the invention where said solution further comprises a phase in form of dissolved gas, said flotation can be performed at least through decompression of said aqueous solution.

According to an implementation of the invention, said aqueous solution can further comprise a surfactant.

According to an implementation of the invention, said aqueous solution can be a produced water.

Alternatively, said aqueous solution can be a produced effluent whose water/oil ratio is above 98%.

Advantageously, a step of primary separation of said phases present in said effluent can be carried out beforehand, through gravity, centrifugal or hydrocyclone-driven separation.

### BRIEF DESCRIPTION OF THE FIGURES

Other features and advantages of the method according to the invention will be clear from reading the description hereafter, given by way of non-limitative example, with reference to the accompanying figures wherein:

FIG. 1 shows the evolution of the Ct/Cinit ratio as a function of the time t of gas injection into a flotation cell, in the case of an aqueous solution sample comprising a tetravalent salt (curve C2) and in the case without tetravalent salt (curve C1),

FIG. 2 shows the evolution of the zeta potential (ZP) of the oil drops as a function of the zirconium chloride concentration ([ZRCL4]) in an aqueous solution,

FIG. 3 shows the evolution of the Ct/Cinit ratio as a function of time t, in cases where no tetravalent salt is injected into an aqueous solution (curve C1), and in cases where a zirconium chloride is added to the aqueous solution in a concentration of 0.5 ppm (curve C2), and

FIG. 4 shows the evolution of the Ct/Cinit ratio as a function of time t, in cases where no tetravalent salt is injected into a produced water sample (curve C1), and in cases where the zirconium chloride is injected in a concentration of 13 ppm (curve C2).

### DETAILED DESCRIPTION OF THE INVENTION

The following definitions are used in the description hereafter:

Petroleum effluent: in the sense of the present invention, it is a fluid collected in at least one production well during enhanced oil recovery in a geological reservoir. This fluid is a mixture comprising part of the hydrocarbons present in the formation (including at least part of the hydrocarbons present in the geological reservoir in oil form), possibly sweep fluid components (such as surfactants, alkaline compounds as in the case of chemical EOR, etc.) and water (possibly in brine form) from the sweep fluid and/or the geological reservoir. The petroleum effluent generally comes in form of a mixture of water and oil. The proportion of water to oil (watercut) in the petroleum effluent can for example range between 5% and 99%, and it generally evolves according to the duration of the field production period,

Produced water: in the sense of the present invention, it is a fluid resulting from a first oil/water separation step applied to a produced effluent. Produced water is generally characterized by a low proportion of residual oil in relation to the aqueous phase, generally below 1%,

Zeta potential of the oil drops: it is the potential related to the electric charge carried by the oil droplets.

The present invention relates to a method for treating an aqueous solution comprising at least an oil phase dispersed as drops within the aqueous solution. More precisely, the present invention relates to the separation of the oil and water phases of an aqueous solution. According to the invention, the oil is a petroleum crude oil.

According to an implementation of the invention, the method according to the invention relates to the treatment of an aqueous solution derived from an enhanced oil recovery operation in a geological formation.

According to an implementation of the invention, the aqueous solution according to the invention is a produced water. According to another implementation of the invention, the aqueous solution according to the invention is a produced effluent whose water/oil proportion is at least 98%. According to an implementation of the invention, a produced effluent with such a watercut may have been obtained after primary separation of the phases present in the effluent, performed for example through gravity, centrifugal or hydrocyclone-driven separation.

The method according to the invention comprises at least the following steps:

1—adding at least one tetravalent salt to the aqueous solution to be treated according to a predetermined concentration,

2—separating by flotation the oil phase and the aqueous phase present in the aqueous solution to which at least the tetravalent salt has been added.

Thus, the purpose of the method according to the invention is to improve the separation of the oil and water phases present in an aqueous solution by adding, prior to implementing a flotation method, a tetravalent salt to the aqueous solution to be treated. According to a first variant of the invention, flotation is performed by injecting a gas into the aqueous solution to be treated (a method known as Induced Gas Flotation). According to this variant of the invention, the injected gas may be air, nitrogen or a gas available on site (natural gas for example). According to a second variant of the invention wherein the aqueous solution further comprises a dissolved gas, flotation can be conducted by decompression of the vapour dissolved gas (a method known as Dissolved Gas Flotation); this decompression can be carried out using a dual-inlet pump allowing for example the aqueous solution to be mixed with vapour. Alternatively, the two flotation variants described above may be combined.

As shown in the application examples described hereafter, adding a tetravalent salt to an aqueous solution comprising dispersed oil drops allows the zeta potential of these oil drops to be lowered. The electrostatic repulsions between the oil drops and the gas bubbles generated by flotation in the aqueous solution during step 2 are then reduced, which enables adhesion of the oil drops to the flotation-generated bubbles, thus promoting rise thereof to the surface. The method according to the invention thus makes the flotation step faster and more efficient.

According to an implementation of the invention, the concentration at which the tetravalent salt is added is predetermined in such a way that the zeta potential of the oil drops dispersed in the aqueous phase ranges between −20 mV and +20 mV. Indeed, a zeta potential in this range provides efficient and fast separation of the oil and water phases present in an aqueous solution, as shown in the application examples below.

Advantageously, the concentration at which the tetravalent salt is added is predetermined in such a way that the zeta potential of the oil drops dispersed in the aqueous phase ranges between −10 mV and +10 mV. Indeed, a zeta potential in this range provides yet more efficient and faster separation of the oil and water phases present in an aqueous solution, as shown in the application examples below.

According to an implementation of the invention, it is possible to determine a concentration in at least one tetravalent salt to be added to the aqueous solution to be treated in such a way that the zeta potential of the oil drops of this solution is contained in a desired range (typically between −20 mV and +20 mV, or preferably between −10 mV and +10 mV) by means of laboratory experiments wherein the tetravalent salt(s) are injected into samples of the aqueous solution to be treated at different concentrations, contained in a concentration range (typically, the tetravalent salt concentration range to be tested is defined by a minimum value of 0.5 ppm and a maximum value of 50 ppm), and zeta potential measurements are performed for each of these concentrations. The zeta potential measurements are performed for example using the Zetasizer Nano Series™ analyzer from Malvern Instruments. It is obvious to specialists that a limited number of such experiments (about ten, at most) is necessary to determine a tetravalent salt(s) concentration allowing a zeta potential in a desired range to be obtained.

According to an implementation of the invention, the number of experiments can be reduced in order to reach the desired zeta potential by using a bisection method for exploring the possible concentration range. In other words, according to an implementation of the invention, zeta potential measurements are performed for the two extreme values of the concentration range (for example for the tetravalent salt(s) concentrations of 0.5 ppm and 50 ppm) and for a median value (advantageously, the median value is selected by considering a logarithmic scale). Then, depending on the value of the zeta potential obtained for the median value, either the concentration value range whose upper limit is the median value or the concentration value range whose lower limit is the median value is divided in two, and a zeta potential measurement is performed for the median value of this new range. This procedure is repeated until a median value for which the zeta potential is in the desired range is determined. The number of experiments to be conducted can thus be reduced.

According to an implementation of the invention, the aqueous solution can further contain at least one surfactant. According to an implementation of the invention, the surfactant is selected from among anionic surfactants or anionic surfactant mixtures containing notably a sulfonate surfactant such as an alkylbenzosulfonate (ABS), an internal olefin sulfonate (IOS), an alkyl glyceryl ether sulfonate (AGES) or an alkyl ether sulfate (AES), a carboxybetaine or a sulfobetaine. As shown in the last application example hereafter, the present invention improves the flotation efficiency even in cases where the aqueous solution to be treated comprises a surfactant.

According to an implementation of the invention, the tetravalent salt is a zirconium salt such as a zirconium chloride, a zirconium sulfate, a zirconium hydroxide or a zirconium acetate. The advantages of these salts are further presented in the application examples hereafter.

According to an implementation of the invention, the zirconium salt is zirconium chloride. This salt advantageously has a low environmental impact. However, this salt may generate a certain corrosion of the metals depending on the concentration thereof. Thus, according to an embodiment of the invention, when the invention is implemented using a zirconium chloride, an anti-corrosion agent can be injected into the aqueous solution simultaneously with the zirconium chloride.

According to an implementation of the invention wherein the aqueous solution is a petroleum effluent, the method according to the invention can further comprise a step of treating the gas resulting from a primary separation of the phases, performed for example through gravity, centrifugal or hydrocyclone-driven separation. Furthermore, the treating method according to the invention applied to a petroleum effluent can comprise a first step of primary separation of the phases, performed for example through gravity, centrifugal or hydrocyclone-driven separation. Besides, the treating method according to the invention applied to a petroleum effluent can comprise oil treatment steps such as dehydration, desalting, etc.

### APPLICATION EXAMPLES

The features and advantages of the method according to the invention will be clear from reading the application examples hereafter.

To implement these examples, samples of an aqueous solution reproducing a produced water with a watercut of 99.95% are prepared according to the protocol as follows: 100 ml of a brine consisting of 7.5 g/L NaCl and 1 wt % Triton X405 are prepared. 45 ml are then poured into a beaker. The solution is stirred at 13,500 rpm using an Ultra-Turrax (IKA T25D (digital) with S25N-18G dispersing tool) and 105 ml VEMO oil are added. The emulsion remains under agitation for 5 min at 13,500 rpm.

Furthermore, the examples are carried out with the equipment and the protocol described below. Thus, a cylindrical laboratory glass column of inside diameter 7 cm and height H=60 cm is used. The column has three cocks allowing samples to be taken, so as to monitor the yield of the process over time. Flotation is conducted by injecting air in all the examples, the air coming from a compressed air network. After an expansion valve set at 2 bars, the desired air flow rate is set at 40 l/h by means of a Kobold® rotameter equipped with a valve and a float. Gas injection occurs through a glass frit with a diameter of 6 cm and a porosity of 17-40 μm. Sealing between the frit support and the column is provided by rubber seals and a steel collar. The size of the bubbles thus generated is in the millimeter range.

A produced water sample as described above is fed into the flotation column. Prior to feeding the gas into the column, the exact initial concentration Cinit in the produced water is determined. Samples are taken at different times in the bottom of the column and the residual oil concentration is determined by dichloromethane extraction and UV-visible spectrophotometry determination.

### Example 1

The first example is implemented from two produced water samples obtained as described above. The produced water has an oil (in form of heavy crude droplets dispersed in water) concentration of 200 ppm (Cinit) and a salinity of [NaCl]=1 mM.

In a first experiment, gas is injected into one of the produced water samples without tetravalent salt addition. In a second experiment, zirconium chloride (ZrCl4) of concentration 0.004 mmol/l is injected into another produced water sample, prior to gas injection. The oil concentration Ct in the water is measured for these two samples during the flotation step.

FIG. 1 shows the evolution of the Ct/Cinit ratio as a function of the time (t) of gas injection into the flotation cell (in other words, the water quality evolution) for each of these experiments. The lower the Ct/Cinit ratio, the higher the efficiency of the flotation treatment and, on the other hand, the closer this ratio to 1, the lower this efficiency. Thus, it can be observed in this figure that the efficiency of the flotation method according to the prior art (i.e. without tetravalent salt addition, curve C1) is low. Indeed, after 10 min flotation, only 36% of the oil has been separated from the aqueous phase present in the produced water. On the other hand, prior injection of the zirconium chloride according to the invention provides a very clear improvement in the flotation efficiency since the water becomes clean (Ct/Cinit<0.05) for times of the order of 6 minutes (see curve C2).

This flotation efficiency improvement provided by the method according to the invention can be explained by a zeta potential decrease (in absolute value) in the presence of zirconium salt, and therefore a reduction of the electrostatic repulsions between the oil drop and the air bubble, which enables adhesion of the oil drops to the air bubbles, and thus faster rise thereof to the surface.

### Example 2

The second example is implemented from a series of nine produced water samples obtained as described above. For this example, the produced water has an oil (in form of heavy crude droplets dispersed in water) concentration of 200 ppm (Cinit) and a salinity of [NaCl]=3 mM.

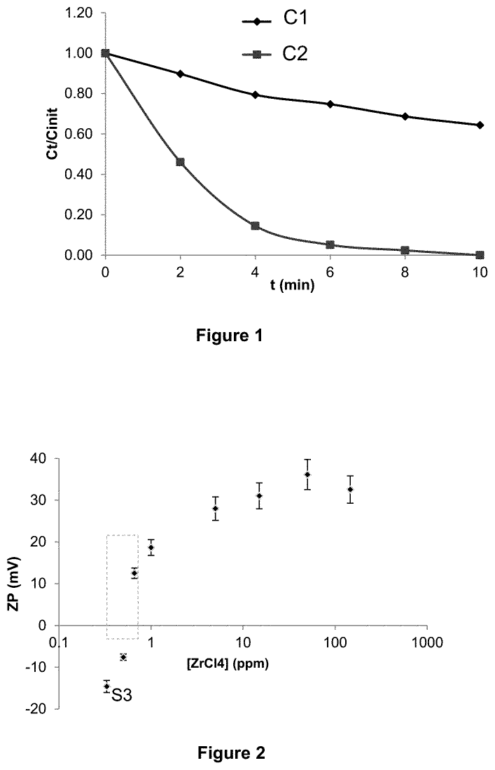

Zirconium chloride at different concentrations is injected into the various produced water samples, corresponding to concentrations between 0.2 ppm and 200 ppm. A measurement of the zeta potential of the oil drops present in each of the samples is performed. FIG. 2 thus shows the evolution of the zeta potential (ZP) of the oil drops as a function of the zirconium chloride concentration ([ZrCl4]).

It is thus noted in this figure that there is a range of concentrations for which the zeta potential of the oil drops is low in absolute value, ranging between −20 mV and +20 mV for example. It can for example be observed that, for a zirconium chloride concentration of 0.5 ppm, the zeta potential of the oil drops is −7 mV and, for a zirconium chloride concentration of 0.7 ppm, the zeta potential of the oil drops is 12 mV. It therefore clearly appears that it is possible, from a very limited number of experiments, to determine a tetravalent salt concentration allowing to reach a zeta potential in the desired range, for example between −20 mV and +20 mV.

Furthermore, it can thus be observed that the evolution of the zeta potential as a function of the zirconium chloride concentration follows a regular single-valued curve. Thus, a method of determining the tetravalent salt concentration allowing a desired concentration to be obtained by bisection appears to be particularly suitable.

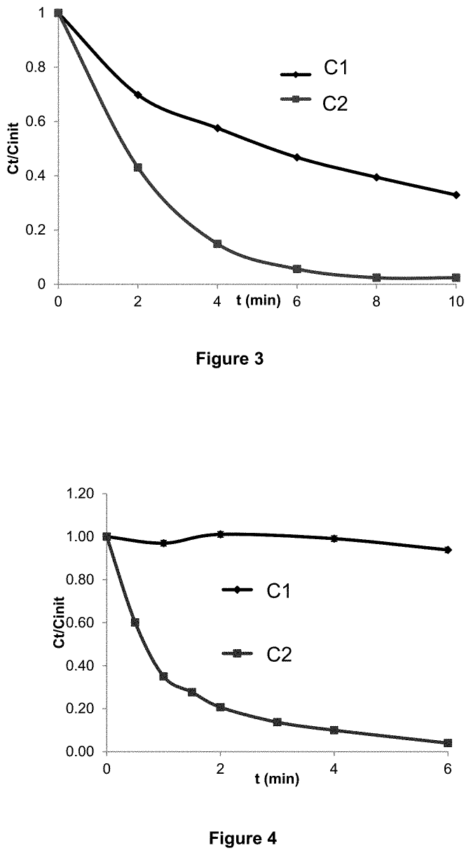

FIG. 3 shows the evolution of the Ct/Cinit ratio as defined in Example 1 as a function of time in cases where no tetravalent salt is injected into the produced water (curve C1), and in cases where a zirconium chloride is added to the aqueous solution in a concentration equal to 0.5 ppm (curve C2). It can be seen in this figure that adding zirconium salt at this concentration allows the flotation efficiency to be greatly improved.

### Example 3

In this example, the salinity of the produced water is [NaCl]=0.2 g/L and it comprises a SDBS (sodium dodecyl benzene sulfonate) surfactant at a concentration of 20 ppm.

In a first experiment, gas is injected into a sample of this produced water without tetravalent salt addition. In a second experiment, zirconium chloride ZrCl4 at a concentration of 13 ppm is injected into another sample of this produced water, prior to gas injection. The zirconium chloride concentration is selected so as to obtain a low zeta potential. Without zirconium chloride and in the presence of 20 ppm SDBS, the zeta potential of the oil droplets is −83 mV and it is of the order of −1 mV after adding 13 ppm zirconium chloride.

Visual observation of the laboratory columns is performed during the flotation process (results not shown). It can be observed that, in the absence of zirconium, the water remains dirty and foam forms at the top of the column. In the presence of zirconium at a concentration of 13 ppm, the water is cleaned in 6 minutes and no foam forms at the top of the column.

Furthermore, the evolution of the oil concentration in the water Ct over time is measured in each column. FIG. 4 shows the evolution of the Ct/Cinit ratio as a function of time, in cases where no tetravalent salt is injected into the produced water (curve C1) and in cases where zirconium chloride is injected at a concentration of 13 ppm (curve C2). A significant improvement in the flotation efficiency can thus be observed in the presence of zirconium, even when the produced water contains a surfactant.

It thus appears that the presence of tetravalent cations in an aqueous solution in which oil droplets are dispersed allows to improve the efficiency of an oil and water phase flotation separation method, even in cases where the aqueous solution also comprises a surfactant.

1. A method for treating an aqueous solution comprising at least an oil phase dispersed as drops in an aqueous phase, the oil being a petroleum crude oil, wherein at least the following steps are carried out:
a) adding at least one tetravalent salt to the aqueous solution according to a predetermined concentration,
b) separating by flotation the oil phase from the aqueous phase present in the aqueous solution to which at least the salt has been added.

2. A method as claimed in claim 1, wherein the concentration is predetermined in such a way that the zeta potential of the oil drops ranges between −20 mV and +20 mV.

3. A method as claimed in claim 1, wherein the concentration is predetermined in such a way that the zeta potential of the oil drops ranges between −10 mV and +10 mV.

4. A method as claimed in claim 1, wherein the tetravalent salt is a zirconium salt.

5. A method as claimed in claim 4, wherein the zirconium salt is a zirconium chloride.

6. A method as claimed in claim 5, wherein at least one anti-corrosion agent is injected simultaneously with the zirconium chloride.

7. A method as claimed in claim 1, wherein the tetravalent salt concentration ranges between 0.05 ppm and 50 ppm.

8. A method as claimed in claim 1, wherein the flotation is performed at least by injecting a gas into the aqueous solution.

9. A method as claimed in claim 8, wherein the injected gas is nitrogen.

10. A method as claimed in claim 1, wherein the solution further comprises a phase in form of dissolved gas, and the flotation is performed at least through decompression of the aqueous solution.

11. A method as claimed in claim 1, wherein the aqueous solution further comprises a surfactant.

12. A method as claimed in claim 1, wherein the aqueous solution is a produced water.

13. A method as claimed in claim 1, wherein the aqueous solution is a produced effluent whose water/oil ratio is above 98%.

14. A method as claimed in claim 13, wherein a step of primary separation of the phases present in the effluent is carried out beforehand, through gravity, centrifugal or hydrocyclone-driven separation.
